(19) United States
(12) Patent Application Publication
(10) Pub. No.: US 2013/0216714 A1
(43) Pub. Date: Aug. 22, 2013

(54) MANUFACTURING METHOD FOR STEEL SHEETS FOR CONTAINERS

(71) Applicants: Takeshi Suzuki, Chiba (JP); Yuka Miyamoto, Kanagawa (JP); Yoichi Tobiyama, Okayama (JP); Hisato Noro, Kanagawa (JP); Masao Inose, Chiba (JP)

(72) Inventors: Takeshi Suzuki, Chiba (JP); Yuka Miyamoto, Kanagawa (JP); Yoichi Tobiyama, Okayama (JP); Hisato Noro, Kanagawa (JP); Masao Inose, Chiba (JP)

(73) Assignee: JFE STEEL CORPORATION, Tokyo (JP)

(21) Appl. No.: 13/823,427

(22) PCT Filed: Sep. 14, 2011
(86) PCT No.: PCT/JP2011/070982

§ 371 Date: Apr. 30, 2013

(30) Foreign Application Priority Data
Sep. 15, 2010 (JP) 2010-207348

(51) Int. Cl. B05D 1/18; C25D 7/06; B05D 3/00

(52) U.S. Cl. CPC B05D 1/18; B05D 3/007; C25D 7/0614
USPC 427/353; 427/435; 205/152; 205/154

(57) ABSTRACT

Disclosed is a manufacturing method for steel sheets for containers that enables reliable, continuous manufacture of steel sheets, with excellent film adhesion qualities, for containers. The manufacturing method for steel sheets for containers is a method in which a film containing Zr is formed on the surface of the steel sheets by immersing, and/or subjecting to electrolytic treatment, the steel sheets in a solution containing Zr ions, F ions, and at least one reaction accelerating component selected from a group including Al ions, boric acid ions, Cu ions, Ca ions, metal Al, or metal Cu.

### TECHNICAL FIELD

The present invention relates to a method of producing a steel sheet for containers that is excellent in terms of film adhesion.

### BACKGROUND ART

Metal containers used for beverages and food are classified broadly into 2-piece cans and 3-piece cans. A two-piece can, typified by a DI is manufactured by drawing and ironing, and then the inner surface of the can Is subjected to painting and the outer surface of the can is subjected to painting and printing. A three-piece can is manufactured by a process including painting the surface of a sheet corresponding to the inner surface of the can and performing printing on the surface of the sheet corresponding to the outer surface of the can, followed by welding of the can body portion.

Cans of either type essentially require a painting process to be performed before or after machining and shaping. For the painting, solvent-based or water-based paints are used This is then followed by baking. In the painting process, waste (e.g. waste solvent) resulting from paints is discharged as industrial waste, and waste gases (mostly carbon dioxide gas) are released into the atmosphere.

In recent years, efforts have been made to reduce such industrial waste and waste gases for global environment conservation. Under these circumstances, film lamination techniques have been attracting attention as a way to replace painting and are spreading in use rapidly.

Meanwhile, steel sheets used as a base material for a laminate film are in most cases provided with a chromate film formed by electrolytic chromating treatment. However, in recent years, amid growing calls in Europe and America for restrictions on the use of harmful substances such as lead and cadmium as well as consideration of working conditions in manufacturing plants, there is a demand for a coating produced without the use of chromate and without reducing the ease of machining in the manufacture of cans.

Under such circumstances, there has been proposed a steel sheet for containers comprising a Zr compound coating to which given amounts of Zr metal and F metal are attached through immersion or electrolysis treatment of the steel sheet in a solution containing Zr ions, F ions, ammonium ions, and nitrate ions (Patent Literature 1). Patent Literature 1 states that the steel sheet for containers exhibits excellent film adhesion.

### CITATION LIST

### Patent Literature

Patent Literature 1: JP 2010-013728 A

### SUMMARY OF INVENTION

### Technical Problems

In the beverage container market, competition in terms of quality between steel sheets for containers and such materials as polyethylene terephthalate, glass, and paper is becoming stronger, and thus steel sheets for containers are also now required to have still better film adhesion. In particular, the film in the neck portion of a can subjected to necking is generally liable to become detached and, hence, there is a demand for a steel sheet for containers in which detachment of the film in such a portion does not occur under harsh conditions.

From a viewpoint of commercialization, is important that a steel sheet having desired properties can be manufactured continuously with no inconsistencies in quality among batches. In particular, in a case where a steel sheet is subjected to surface treatment using a solution containing given components, repeated uses if possible, of the same solution over an extended period of time is of great significance from the viewpoint of the environment and cost.

The inventors of the present invention continuously produced steel sheets by the method of producing steel sheet for containers described in Patent Literature 1, studied the film adhesion in the neck portion, and found that while the steel sheets initially produced exhibited desired film adhesion, the film adhesion degraded as the continuous production proceeded.

In view of the above, an object of the present invention is to provide a method of continuously and consistently producing steel sheets for containers exhibiting excellent film adhesion.

### Solution to Problems

To achieve the above object, the present inventors carried intensive studies and found that use of a solution containing at least one reaction accelerating component selected from the group consisting of it ions, borate ions, Cu ions, Ca ions, Al metal, and Cu metal is effective.

Accordingly, the inventors of the present invention found that the problems can be solved by adopting the features described below.

(1) A method of producing a steel sheet for containers, comprising subjecting a steel sheet to immersion or electrolysis treatment in a solution containing Zr ions and F ions and at least one reaction accelerating component. selected from the group consisting of Al ions, borate ions, Cu ions, Ca ions, Al metal, and Cu metal to form a Zr-containing coating on a surface of the steel sheet.
(2) The method of producing a steel sheet for containers according to (1), wherein a molar ratio between the Zr ions and the reaction accelerating component (moles of Zr ions/moles of reaction accelerating component) is 0.002 to 2.
(3) The method of producing a steel sheet for containers according to (1) or (2), wherein an amount of the attached. Zr-containing coating is 1 mg/m² to 100 mg/m² in terms of Zr metal and 0.1 mg/m² or less in terms of F.
(4) The method of producing a steel sheet for containers according to any one of (1) to (3), wherein the solution further contains phosphate ions, and wherein an amount of P in the Zr-containing coating is 0.1 mg/m² to 50 mg/m².
(5) The method of producing a steel sheet for containers according to any one of (1) to (4), wherein the solution. further contains phenolic resin, and wherein an amount of C in the Zr-containing coating is 0.1 mg/m² to 50 mg/m².
(6) The method or producing a steel sheet for containers according to any one of (1) to (5), wherein the solution further contains ammonium ions and/or nitrate ions.
(7) The method of producing a steel sheet for containers according to any one of (1) to (6), wherein the steel sheet is a surface-treated steel sheet comprising on at least one side thereof a surface treatment layer containing 10 mg/m² to 1000 mg/m² of Ni in terms of Ni metal, or 100 mg/m² to 15000 mg/m² of Sn in terms of Sn metal.
(8) The method of producing a steel sheet for containers according to any one of (1) to (7), wherein the steel sheet is plated with Ni or an Fe—Ni alloy on a surface thereof and thus formed with a base Ni layer, and Sn plating is provided on the base Ni layer, so that part of the Sn plating and part or the whole of the base Ni layer are alloyed by tin melting treatment to form a Sn plating layer containing Sn islands, wherein the base Ni layer contains 5 mg/m² to 150 mg/m² of Ni in terms of Ni metal, and wherein the Sn plating layer contains 300 mg/m² to 3000 mg/m² of Sn in terms of Sn metal.
(9) The method of producing a steel sheet for containers according to any one of (1) to (8), further comprising, after forming the Zr-containing coating on the surface of the steal sheet, cleaning by immersion in or spraying with hot water at a temperature of 40° C. or more for 0.5 seconds or more.

### Advantageous Effects of Invention

The present invention provides a method of continuously and consistently producing steel sheets for containers exhibiting excellent film adhesion.

### DESCRIPTION OF EMBODIMENTS

A method of producing a steel sheet for containers is described in detail below.

The present invention is characterized in that the solution used to form the Zr-containing coating on the surface of the steel sheet contains at least one reaction accelerating component selected from the group consisting of Al (aluminum) ions, borate ions, Cu (copper) ions, Ca (calcium) ions, Al metal (aluminum), and Cu metal (copper).

The present inventors studied the invention described in Patent Literature 1 and found that immersion or electrolysis treatment (in particular, cathodic electrolysis) of the steel sheet in a solution for a long time results in redaction in the amount of the coating that is attached and, hence, degradation of the properties of the steel sheet. While the reason for the above is not fully understood, it is assumed that the concentration of free F ions in the solution increases as time passes, inhibiting the formation of the coating. Thus, the present inventors found that the above reaction accelerating components, if added to the solution, form, complexes with F ions, and hence the concentration of free F ions decreases, so that formation of the coating progresses sufficiently.

Hereinbelow, the steel sheet and the solution used in the present invention are described in detail.

### <Steel Sheet>

The steel sheet used in the invention is not specifically limited and may be any steel sheet normally used as material for containers. The method of producing such material sheet and the properties thereof are also not specifically limited; the material sheet is produced through a process starting with a normal billet producing step, followed by such steps as hot rolling, pickling, cold rolling, annealing, and temper rolling.

To secure the corrosion resistance required of containers, the steel sheet is preferably formed with a surface treatment layer on the surface thereof.

According to a first configuration of the surface treatment laver, a surface treatment layer containing one or both of Ni (nickel) and Sn (tin) is preferably applied; the method of application is not specifically limited. Use may be made of known techniques such as electroplating, vacuum vapor deposition, and sputtering, where plating may be followed by heat treatment in order to provide a diffusion layer. Applying Fe—Ni alloy plating in lieu of Ni-plating does not change the essence of the present invention.

In the surface treatment layer thus provided containing one or more of Ni and Sn, it is preferable that Ni is contained in an amount of 10 mg/m² to 1000 mg/m² in terms of Ni metal, and Sn in an amount of 100 mg/m² to 15000 mg/m² in terms of Sn metal.

Sn exhibits enhanced ease of machining, excellent weldability and corrosion resistance, and for such effects to be produced, Sn is preferably contained in an amount 100 mg/m² or more in terms of Sn metal. To secure sufficient weldability, Sn is preferably provided in an amount of 200 mg/m² or more and, to secure sufficient ease of machining, in an amount of 1000 mg/m² or more. While Sn's effects of enhancing ease of machining and weldability increase as the amount of attached Sn increases, providing Sn in an amount exceeding 15000 mg/m² is economically disadvantageous because the effects of enhancing corrosion resistance are saturated in that range. Thus, the amount of attached Sn is preferably kept at 15000 mg/m² or less in terms of Sn metal. Reflow treatment, when performed after Sn plating, forms a Sn alloy layer, which further enhances corrosion resistance.

Ni produces effects in paint adhesion, film adhesion, corrosion resistance, and weldability, and to that end, Ni is provided preferably in an amount of 10 mg/m² or more in terms of Ni metal. While Nis effects of enhancing film adhesion, corrosion resistance, and weldability increase as the amount of attached Ni increases, providing Ni in an amount exceeding 1000 mg/m² is uneconomical because such enhancement effects are saturated in that range. Thus, the amount of attached Ni is preferably kept at 10 mg/m² or more and 1000 mg/m² or less in terms of Ni metal.

The amounts of Ni metal and Sn metal in the above surface treatment layer can be measured by, for example, X-ray fluorescence spectrometry. In this case, a calibration curve representing the amount of Ni metal is determined in advance using a sample having an amount of attached Ni for which the amount of Ni metal is known in order to relatively determine the amount of Ni metal using the calibration curve. Likewise with the amount of Sn metal, a calibration curve for the amount of Sn metal is determined in advance using a sample having an amount of attached Sn for which the amount of Sn metal is known in order to relatively determine the amount of Sn metal using the calibration curve.

A second configuration of the surface treatment layer is exemplified by a composite plating layer comprising a base Ni layer provided on the surface of a steel sheet and a Sn island plating layer formed on the base Ni layer.

The base Ni layer herein is a plating layer containing Ni formed on at least one side of the steel sheet and may be a Ni metal plating layer of Ni metal or an Fe—Ni alloy plating layer formed of Fe—Ni alloy plating. The Sn island plating layer is preferably an alloy plating layer formed by providing Sn plating on the base Ni layer and allowing part or the whole of the base Ni layer to alloy with part of the Sn plating layer through tin melting treatment. Because it is difficult to form Sn islands as described above by providing Sn plating on the plating layer composed solely of Ni and applying tin melting treatment, an Fe—Ni alloy plating layer is preferable as a base Ni layer. Such a Ni plating layer and a En island plating layer are described in detail below.

The base Ni layer composed of Ni or an Fe—Ni alloy is provided to improve corrosion resistance. Because Ni is a high corrosion-resistance metal, plating the surface of a steel sheet for containers with Ni, as is done in the present invention, improves the corrosion resistance of an alloy layer containing Fe and Sn that is formed in tin me M ting treatment.

The effects of improving the corrosion resistance of an alloy layer achieved by Ni plating depend on the amount of applied Ni; when the amount of Ni metal in the base Ni layer is 5 mg/m² or more, the effects of improving corrosion resistance is significantly great. The effects of improving corrosion resistance increase with the amount of Ni in the base Ni layer, but when the amount of Ni in the base Ni layer exceeds 150 mg/m², not only are the effects of improving corrosion resistance saturated, but because Ni is an expensive metal, plating with Ni in an amount exceeding 150 mg/m² is disadvantageous from an economical viewpoint. Accordingly, the amount of Ni in the base Ni layer is preferably 5 mg/m² to 150 mg/m².

In the case where the base Ni layer is formed by diffusion plating, the surface of the steel sheet is plated with Ni, and subsequently diffusion treatment is performed in an annealing furnace to form a diffusion layer. Before or after the diffusion treatment or simultaneously therewith, nitriding may be performed, Even In the case where nitriding is performed, the effects of Ni as the base Ni layer of the invention and the effects of the nitriding treatment layer can both be produced without interference between them.

Plating with Ni and plating with an Fe—Ni alloy can be performed by, for example, a known method generally employed in electroplating (e.g., cathodic electrolysis).

The above Ni plating or Fe-—Ni plating is followed by Sn plating. “Sn-plating” herein denotes not only plating with Sn metal but plating with Sn metal into which irreversible impurities have been mixed or Sn metal to which a trace amount of elements have been added. Sn plating may be performed by any appropriate method that is not specifically limited and may be performed by, for example, a known electroplating method or a method whereby a steel sheet is immersed in molten Sn.

The Sn plating layer formed by the Sn plating described above is provided to improve corrosion resistance and weldability. Because Sn per se has a high corrosion resistance, not only Sn metal but also a Sn alloy formed by tin melting treatment (reflow treatment) described later can exhibit excellent corrosion resistance and weldability

Note that, in this case, the Sn plating layer is formed so as to contain tin islands. This is because, if the whole surface of a steel sheet were to be plated with Sn, the steel sheet might be exposed to a temperature at the melting point (232° C.) or a higher temperature during heat treatment following film lamination or application of a paint, making it impossible to secure film adhesion because of melting or oxidation of Sn. Therefore, Sn islands are formed, and the Fe—Ni base, which corresponds to the sea area, is exposed (area which does not melt) to ensure film adhesion.

Sn's excellent corrosion resistance starts to increase significantly when the amount of Sn metal is about 300 mg/m², and improves at an increasing rate as the Sn content increases. Accordingly, the amount of Sn metal in the Sn plating layer containing Sn islands is preferably 300 mg/m² or more. Further, because the effects of improving corrosion resistance are saturated when the amount of Sn metal exceeds 3000 mg/m², the Sn content is preferably not more than 3000 mg/m² from an economical viewpoint.

Sn, having a low electric resistance, is soft, expands when pressurized between electrodes during welding, and thus secures a stable energization region, thereby exhibiting an excellent weldability. Such excellent weldability can be exhibited when Sn metal is in an amount of 100 mg/m² or more. In the above range of the amount of Sn metal, where an excellent corrosion resistance is exhibited, the effects of improving weldability are not saturated. Accordingly, to secure excellent corrosion resistance and weldability, the amount of Sn metal is preferably in a range of not less than 300 mg/m² and not more than 3000 mg/m².

The above Sn plating is followed by tin melting treatment (reflow treatment). The tin melting treatment is performed to melt Sn, alloy molten Sn with a base steel sheet or a base metal (e.g., y base Ni layer), and form an Sn—Fe alloy layer or an Sn—Fe—Ni alloy layer to thereby improve the corrosion resistance of the alloy layer and also form Sn alloy islands. The Sn alloy islands can be formed by appropriately controlling tin melting treatment.

### <Solution (Treatment Solution))>

The steel sheet may be provided with a Zr-containing coating by a method whereby the steel sheet is immersed or subjected to electrolysis (especially catholysis) in a solution containing Zr ions, F ions, and at least one reaction accelerating component selected from the group consisting of Al ions, borate ions, Cu ions, Ca ions, Al metal, and Cu metal.

However, the method using immersion is industrially disadvantageous because the base is etched and various kinds of coatings are formed, resulting in inconsistencies in the amount of attached coating and, moreover, a longer treatment time. On the other hand, cathodic elecrolysis can yield a uniformly formed coating owing to surface cleaning realized by forced charge transfer and generation of hydrogen in the s eel sheet interface combined with attachment promoting effects produced b an increase in pH.

Further, the coexistence of nitrate ions and ammonium ions in the solution enables the cathodic elect of sis to be accomplished in a short time period of several seconds to several tens of seconds and promotes deposition of a Zr-containing coating containing Zr oxides and Zr phosphorates having excellent effects of enhancing corrosion resistance and adhesion, making cathodic electrolysis industrially very advantageous. Therefore, it is desirable to use cathodic electrolysis to provide the Zr-containing coating of the invention and, in particular, cathodic electrolysis in a treatment solution where nitrate ions and ammonium ions coexist is preferable.

The Zr ion concentration in the solution is preferably 0.008 mol/l to 0.07 mol/l and more preferably 0.02 mol/l to 0.05 mol/l to achieve efficient deposition of the Zr-containing coating and obtain a steel sheet with yet better film adhesion.

The Zr ion supply source to the solution is not specifically limited and is exemplified by K₂ZrF₆, Na₂ZrF₆, H₂Zr₆, and (NH₄)ZrF₆.

F ions in, the solution are necessary to keep Zr ions stable in the bath, the concentration of the F ions preferably being 0.024 mol/l to 0.63 mol/l and more preferably 0.048 mol/l to 0.42 mol/l.

The F ions may be supplied to the solution in any manner as appropriate and may be supplied in the form of, for example, K₂ZrF₆, Na₂ZrF₆, H₂ZrF₆, or (NH₄)ZrF₆, which also serves as Zr material, or in the form of NaF, HF, (NH₄)F, separately from Zr ion supply source.

The reaction accelerating component is exemplified by Al ions, borate ions, Cu ions, Ca ions, Al metal, and Cu metal. The Zr ions in the solution form complexes with F ions and exist stably as such. As the Zr-containing coating precipitates, the ions coordinated with Zr ions are released, and the concentration of the free F ions increases with the passage of time. As the concentration of the free F ions increase, the deposition efficiency of the Zr-containing coating decreases, making stable film adhesion impossible. However, the component added to the solution facilitates formation of complexes with F ions, limiting the increase in the concentration of the free F ions in the solution. Addition of borate ions or Al metal, among others, is preferable for the outstanding effects produced thereby such that a fine-textured coating having uniform asperity is formed, and that a steel sheet with a still better film adhesion is obtained.

The reaction accelerating component is contained in a solution preferably in an amount of 0.002 to 2 and more preferably 0.02 to 0.2 in terms of molar ratio between Zr ions and reaction accelerating component (moles of Zr ions/moles of reaction accelerating component).

The Al ion supply source to the solution is not specifically limited and is exemplified by Al₂(SO₄)₃.

The borate ion supply source to the solution is not specifically limited and is exemplified by H₃BO₃.

The Cu ion supply source to the solution is not specifically limited and is exemplified by CuSO₄ and CuCl₂.

The Ca ion supply source to the solution is not specifically limited and is exemplified by CaCl₂.

In the case where Al metal, is used particles thereof, for example, having a diameter of 3 mm and a purity of 99% or more may be suitably used.

In the case where Cu metal is used, a copper sheet or copper particles, for example, having a purity of 99% or more may be suitably used.

The molar quantities of individual components in the solution may be measured appropriately with a known measuring instrument (e.g., an atomic absorption spectrophotomoter).

The solvent in the solution is normally water. The solvent may contain, for example, an organic solvent, provided that the effects produced by the invention are not impaired.

The solution may further contain phosphate ions. When the solution contains phosphate ions, the Zr-containing coating contains P (phosphorus), which improves corrosion resistance and adhesion.

The concentration of phosphate ions in the solution is adjusted appropriately so that the Zr-containing coating described later contains a given amount of P and is typically about 0.007 mol/l to 0.15 mol/l.

The solution may further contain phenolic resin. When the solution contains phenolic resin, the Zr-containing coating contains C (carbon), which further improves corrosion resistance and adhesion.

The concentration of phenolic resin in the solution is adjusted appropriately so that the Zr-containing coating described later contains a given amount of C and is typically about 0.5 g/l to 45 g/l.

The concentration of ammonium ions or nitrate ions in the solution may he adjusted as appropriate according to the production facilities and production rate (capacity). An ammonium ion concentration in a range of about 100 ppm by weight to 10000 ppm by ht is particularly preferable, and a nitrate ion concentration in a range of about 1000 ppm by weight to 20000 ppm by weight is particularly preferable to obtain a steel sheet having a still better film adhesion.

### <Treatment Conditions>

According to the invention, a steel sheet is immersed in or subjected to electrolysis treatment in the above solution to form a containing coating.

The steel sheet is immersed in a solution under conditions that vary with, for example, the composition of the solution used and preferably for a period of 1 second to 10 seconds and more preferably 3 seconds to 5 seconds to form a desired amount of attached Zr-containing coating.

The electrolysis treatment is performed under conditions that vary with, for example, the composition of the solution used; to form a desired amount of attached Zr-containing coating, the current density is preferably 0.01 A/dm² to 20 A/dm² and more preferably 0.5 A/dm² to 10 A/dm². The electrolysis is performed for a period of time that is selected as optimal for the current density, preferably 0.01 seconds to 10 seconds, more preferably 1 second to 5 seconds.

### <Zr-containing Coating>

The Zr-containing coating formed in the above treatment contains deposits of Zr ions in the solution (Zr compounds). The function of the Zr compounds is to secure corrosion resistance and adhesion. The Zr compounds are thought to be composed mainly of hydrous oxides of Zr, which include Zr oxides and Zr hydroxides, and Zr phosphorates and possess excellent corrosion resistance and adhesion.

Thus, as the amount of Zr-containing coating increases, corrosion resistance and adhesion start to improve and, when the amount of the Zr-containing coating reaches 1 mg/m² or more, the corrosion resistance and adhesion achieved pose no problem in practical use. Further, although the effects of improving corrosion resistance and adhesion also increase as the amount of Zr-containing coating increases, when the amount of the Zr coating exceeds 100 mg/m² in terms of Zr metal the Zr-containing coating grows excessively thick, so that the adhesion of the Zr-containing coating itself degrades, while the electric resistance increases, possibly reducing weldability. Accordingly, the amount of the attached Zr-containing coating is preferably 1 mg/m² to 100 mg/m² in terms of Zr metal. In particular, an amount of 1 mg/m² to 10 mg/m² is more preferable, and 1 mg/m² to 8 mg/m² is still more preferable.

While excellent corrosion resistance and adhesion are exhibited as the amount of Zr phosphorates increases, such effects can be distinctively recognized when the amount of P in the Zr-containing coating is 0.1 mg/m² or more. Further, although the effects of improving corrosion resistance and adhesion also increase as the amount of P increases, when the amount of P exceeds 50 mg/m², the adhesion of the Zr-containing coating itself degrades while the electric resistance increases, possibly degrading weldability. Therefore, the amount of p in the Zr-containing coating preferably 0.1 mg/m² to 50 mg/m². In particular, an amount of 0.1 mg/m² to 10 mg/m² is mere preferable, and 0.1 mg/m² to 8 mg/m² is still more preferable,

The Zr-containing coating, even when used alone, has excellent practical properties whereas a phenolic resin coating, when used alone, only exhibits certain degrees of effects and does not have sufficient practical performances. However, a combination of a Zr compound and a phenolic resin exhibit yet better practical performances.

The function of the phenolic resin is to secure adhesion. Phenolic resin, itself an organic substance, has excellent adhesion to a laminate film.

Thus, as the amount of phenolic resin coating increases, adhesion starts to improve and, when the amount of C in the Z-containing coating reaches 0.1 mg/m² or more, the degree of achieved adhesion poses no problem practical use. The effects of t proving the adhesion also increase as the amount of C further increases, but when the amount of C exceeds 50 mg/m², the electric resistance increases, possibly degrading weldability. Therefore, the amount of C in the Zr-containing coating is preferably 0.1 mg/m² to 50 mg/m². In particular, an amount of 0.1 mg/m² to 10 mg/m² is more preferable, and 0.1 mg/m² to 8 mg/m² is still more preferable.

Because F ions are contained in the solution, a small amount of F ions are incorporated into the coating together with the Zr compounds. Although F atoms in the coating do not significantly affect normal film adhesion (first adhesion, the F atoms may degrade adhesion (second adhesion) during high-temperature sterilization treatment such as retorting treatment and resistance to rusting or corrosion under the coating. This is thought to be attributable to the fact that the F atoms in the coating dissolve into steam or a corrosive solution and break the bond with an organic coating or corrode the base steel. sheet.

Because the degradation of such properties becomes apparent when the amount of F (amount of F atoms) in the coating exceeds 0.1 mg/m², the amount of F is preferably 0.1 mg/m² or less. An amount of 0.01 mg/m² or less, in particular, is more preferable; the minimum amount is not specifically limited but is preferably 0.

To set the amount of F to 0.1 mg/m² or less, cleaning treatment is performed by immersion in or spraying of warm water after formation of the Zr-containing coating; the amount of F can be reduced by raising the treatment temperature or extending the treatment time.

Thus, to set the amount of F in the coating to 0.1 mg/m² or less, immersion in or spraying of warm water at 40° C. or more for 0.5 seconds or more is preferable.

The amounts of zirconium metal (Zr), F (phosphorus), and F (fluorine) contained in the Zr-containing coating of the invention can be measured by quantitative analysis such as X-ray fluorescence spectrometry. On the other hand, the amount of C (carbon) can be measured by subtraction of the amount of C existing in the steel sheet using a TOC (total organic carbon) analyzer.

### EXAMPLES

Examples of the invention and Comparative Examples are described below. The conditions used therein and results obtained are shown in Table 1.

### <Surface Treatment Layer on Steel Sheet>

Methods, (treatment method 0) to (treatment method 3), described below were used to provide a surface treatment layer on a steel sheet having a thickness of 0.17 mm to 0.23 mm.

(treatment method 0) A cold-rolled, and then annealed and temper-rolled material sheet was degreased and pickled to produce a steel sheet.
(treatment method 1) A cold-rolled, and then annealed and pressure-adjusted raw sheet was degreased, pickled, and plated with Sn using a ferrostan bath to produce an Sn-plated steel sheet.
(treatment method 2) A cold-rolled, and then annealed and Pressure-adjusted raw sheet was degreased, pickled, and plated with Ni using a Watts bath to produce an Ni plated steel sheet.
(treatment method 3) A cold-rolled steel base material (steel sheet) having a thickness of 0.17 mm to 0.23 mm was degreased, pickled, Ni-plated using a Watts bath, formed with an Ni diffusion layer during annealing, degreased and pickled, plated with Sn using a ferrostan bath, and subsequently subjected to tin melting treatment to produce an Ni- and Sn-plated steel sheet having a Sn alloy layer.

In the case where the treatment by (treatment method 3) was performed, observation of the surface with an cal microscope for evaluating the state of Sn islands confirmed formation of islands distributed over the whole surface.

Subsequently, the steel sheets obtained by the above methods (treatment method 0) to (treatment method 3) were subjected to cathodic electrolysis under cathodic electrolysis conditions shown in Table 1 to form a Zr-containing coating, whereupon water washing described below was performed to produce steel sheets for containers. (Water Washing Treatment) Immersion was performed in warm water at 40° C. or more for 3 seconds.

The solution composition in Table 1 shows the concentrations of individual components in the aqueous solution.

The phenolic resin, used in Table 1 is water-soluble phenolic resin modified with N,N-diethanolamine (weight average molecular weight: 5000).

The Al metal used in Table 1 is in the form of particles having a diameter of 3 mm and of a purity of 99% or more; the Cu metal used was a copper foil having a purity of 99% or more.

In Table 1, the borate ion supply source is borate; the calcium ion supply source is calcium chloride; the copper ion supply source is copper chloride; and the aluminum ion supply source is Al₂(SO₄)₃.

The amounts of attached Ni and Sn in the base plating layer and the amounts of Zr, P, and F in the Zr-containing coating are obtained by comparison with the calibration sheet on which the amounts of attached elements are known through chemical analysis by X-ray fluorescence spectrometry. The amount of C was measured by subtraction of the amount of C existing in the steel sheet using a TOC (total organic carbon) analyzer.

### <Initial Film Adhesion>

Each of the test materials obtained in Examples and Comparative Examples in Table 1 was laminated on both sides thereof with a 20 μm-thick PET film at 200° C. and subjected to drawing and ironing to shape a can, which then underwent a necking process before being subjected to a 30-minute retorting treatment at 120° C. to perform evaluation based on the state of detachment of the film in the neck portion of the can.

Specimens with no detachment were marked ©; specimens with slight detachment posing no practical problem in use were marked O; specimens with partial detachment posing practical problems in use were marked Δ; and specimens with detachment in most parts were marked X. The results are all shown in Table 3.

For practical use, ratings represented by “©” and “O” are required.

### <Continuous Treatment>

Production of steel sheets was continued for 3 consecutive days, under electrolysis treatment conditions in Examples and Comparative Examples described in Table 1, and the film adhesion of the steel sheets finally obtained was evaluated by the same method as used in the above <Initial Film Adhesion>.

Specimens whose film adhesion did not change were marked. “O”; specimens whose film adhesion degraded were marked “X.”

TABLE 1

| | | | | | | Cathodic electrolytes | | |
|---|---|---|---|---|---|---|---|---|
| | | | | | | | Amount of | Reaction |
| | | Surface Treatment Layer | | | | | ions | accelerating |
| | | | Ni | Sn | State of | Solution | in solution | component in |
| | No. | Treatment | (mg/m²) | (mg/m²) | Sn islands | composition | (mol/l) | solution |
| Example | 1 | Treatment 0 | — | — | — | Potassium hexaflourozirconate 10.6 g.l | 0.037 | borate ions 0.019 mol/l |
| Example | 2 | Treatment 0 | — | — | — | Potassium hexaflourozirconate 10.6 g/l | 0.037 | Metal Al 150 g/l |
| Example | 3 | Treatment 1 | — | 1000 | — | Potassium hexaflourozirconate 10.6 g/l | 0.037 | Metal Cu 150 g/l |
| Example | 4 | Treatment 1 | — | 1000 | — | Potassium hexaflourozirconate 10.6 g/l | 0.037 | Calcium ions 0.035 mol/l |
| Example | 5 | Treatment 1 | — | 1000 | — | Potassium hexaflourozirconate 10.6 g/l | 0.037 | Copper ions 0.058 mol/l |
| Example | 6 | Treatment 1 | — | 1000 | — | Potassium hexaflourozirconate 10.6 g/l | 0.037 | Aluminum ions 0.1 mol/l |
| Example | 7 | Treatment 1 | — | 1000 | — | Potassium hexaflourozirconate 10.6 g/l | 0.037 | borate ions 18.3 mol/l |
| Example | 8 | Treatment 1 | — | 1000 | — | Potassium hexaflourozirconate 10.6 g/l | 0.037 | borate ions 0.25 mol/l |
| Example | 9 | Treatment 2 | 500 | — | — | Potassium hexaflourozirconate 1.6 g/l + | 0.005 | borate ions 1.2 mol/l |
| | | | | | | phosphoric acid 1.2 g/l | | |
| Example | 10 | Treatment 2 | 500 | — | — | Potassium hexaflourozirconate 1.6 g/l + | 0.005 | Metal Al |
| | | | | | | phosphoric acid 0.7 g/l | | 1.8 g/l |
| Example | 11 | Treatment 3 | 70 | 1000 | ◯ | Potassium hexaflourozirconate 18.3 g/l + | 0.065 | Metal Al |
| | | | | | | phosphoric acid 6.9 g/l + | | 1.8 g/l |
| | | | | | | ammonium nitrate 1.1 g/l | | |
| Example | 12 | Treatment 3 | 70 | 1000 | ◯ | Potassium hexaflourozirconate 1.2 g/l + | 0.037 | borate |
| | | | | | | phosporic acid 0.7 g/l + | | 1.2 mol/l |
| | | | | | | phenolic resin 1.1 g/l + | | |
| | | | | | | ammonium nitrate 1.8 g/l | | |
| Example | 13 | Treatment 3 | 70 | 1000 | ◯ | Potassium hexaflourozirconate 10.6 g/l + | 0.037 | borate ions |
| | | | | | | phosphoric acid 1.2 g/l + | | 0.017 mol/l |
| | | | | | | phenolic resin 0.7 g/l + | | |
| | | | | | | ammonium nitrate 1.1 g/l | | |
| Example | 14 | Treatment 3 | 70 | 1000 | ◯ | Potassium hexaflourozirconate 10.6 g/l + | 0.037 | borate ions |
| | | | | | | phosphoric acid 1.2 g/l + | | 19 mol/l |
| | | | | | | phenolic resin 0.7 g/l + | | |
| | | | | | | ammonium resin 1.1g/l | | |
| Compar. | 1 | Treatment 1 | — | 1000 | — | Potassium hexaflourozirconate 10.6 g/l | 0.037 | — |
| Compar. | 2 | Treatment 2 | 500 | — | — | Potassium hexaflourozirconate 1.6 g/l + | 0.005 | — |
| | | | | | | phenolic resin 0.7 g/l | | |
| Compar. | 3 | Treatment 3 | 70 | 1000 | ◯ | Potassium hexaflourozirconate 10.6 g/l + | 0.037 | — |
| | | | | | | phosphoric acid 1.2 g/l + | | |
| | | | | | | phenolic resin 0.7 g/l + | | |
| | | | | | | ammonium nitrate 1.1 g/l | | |

| | | Cathodic electrolytes | | | | | | | |
|---|---|---|---|---|---|---|---|---|---|
| | | Current | | | | | | Evaluation | |
| | | density | Electrolysis | Zr-containing coating | | | | Film | Continu- |
| | No. | (A/ [symbol] | time (sec) | Zr (mg/m²) | F (mg/m²) | P (mg/m²) | C (mg/m²) | adhesion | abililty |
| Example | 1 | 6 | 2 | 19.2 | 0.01 or less | — | — | ◯ | ◯ |
| Example | 2 | 8 | 2 | 18.2 | 0.01 or less | — | — | ◯ | ◯ |
| Example | 3 | 6 | 2 | 18 | 0.01 or less | — | — | ◯ | ◯ |
| Example | 4 | 8 | 2 | 18.9 | 0.01 or less | — | — | ◯ | ◯ |
| Example | 5 | 6 | 2 | 18.8 | 0.01 or less | — | — | ◯ | ◯ |
| Example | 6 | 6 | 2 | 16.9 | 0.01 or less | — | — | ◯ | ◯ |
| Example | 7 | 7 | 6 | 38.2 | 0.01 or less | — | — | ◯ | ◯ |
| Example | 8 | 6 | 2 | 19.3 | 0.01 or less | — | — | ◯ | ◯ |
| Example | 9 | 8 | 2 | 24 | 0.01 or less | 7.9 | — | ◯ | ◯ |
| Example | 10 | 8 | 2 | 25 | 0.01 or less | — | 5.2 | ◯ | ◯ |
| Example | 11 | 6 | 2 | 18 | 0.01 or less | 9.1 | — | ⊚ | ◯ |
| Example | 12 | 6 | 2 | 19.2 | 0.01 or less | 6.7 | 11.2 | ⊚ | ◯ |
| Example | 13 | 5 | 1 | 14.2 | 0.01 or less | 5.2 | 8.7 | ◯ | ◯ |
| Example | 14 | 7 | 6 | 40.2 | 0.01 or less | 13.2 | 19.2 | ◯ | ◯ |
| Compar. | 1 | 6 | 2 | 18.9 | 0.01 or less | — | — | ◯ | X |
| Compar. | 2 | 8 | 2 | 24.2 | 0.01 or less | — | 10.9 | ◯ | X |
| Compar. | 3 | 6 | 2 | 19.1 | 0.01 or less | 6.5 | 11.5 | ⊚ | X |

[symbol]

indicates data missing or illegible when filed

As shown in Table 1, the steel sheets for containers obtained by the method according to the invention exhibited excellent initial film adhesion. In Examples, the amounts of attached components decreased little after the continuous treatment, and the film adhesion remained stable, enabling desirable, continuous treatment to be performed.

It was confirmed that Example 12, where the molar ratio between the reaction accelerating component and Zr ions (moles of Zr ions/moles of reaction accelerating component) is in a range of 0.002 to 2, is more excellent in terms of film adhesion than Examples 13 and 14, where the molar ratio is not within that range.

In Comparative Examples 1 to 3 containing no reaction accelerating component, the initial film adhesion was excellent, but the amounts of attached components decreased greatly after the continuous treatment, so that the film adhesion degraded, indicating inferiority in terms continuous treatment.

1-9. (canceled)

10. A method producing a steel sheet for containers, comprising subjecting a steel sheet to immersion or electrolysis treatment in a solution containing Zr ions and F ions and at least one reaction accelerating component selected from the group consisting of Al ions, borate ions, Cu ions, Ca ions, Al metal, and Cu metal to form a Zr-containing coating on the surface of the steel sheet.

11. The method of producing a steel sheet for containers according to claim 10, wherein a molar ratio of the Zr ions to the reaction accelerating component (moles of Zr ions/moles of reaction accelerating component) is 0.002 to 2.

12. The method of producing a steel sheet for containers according to claim 10, wherein an amount of the attached Zr-containing coating is 1 mg/m² to 100 mg/m² in terms of Zr metal and 0.1 mg/m² or less in terms of F.

13. The method of producing a steel sheet for containers according to claim 10, wherein the solution further contains phosphate ions, and wherein an amount of P in the Zr-containing coating is 0.1 mg/m² to 50 mg/m².

14. The method of producing a steel sheet for containers according to claim 10, wherein the solution further contains phenolic resin, and wherein an amount of C in the Zr-containing coating is 0.1 mg/m² to 50 mg/m².

15. The method of producing a steel sheet for containers according to claim 10, wherein the solution further contains ammonium ions and/or nitrate ions.

16. The method of producing a steel sheet for containers according to claim 10, wherein the steel sheet is a surface-treated steel sheet comprising on at least one side thereof a surface treatment layer containing 10 mg/m² to 1000 mg/m² of Ni in terms of Ni metal, or 100 mg/m² to 15000 mg/m² of Sn in terms of Sn metal.

17. The method of producing a steel sheet for containers according to claim 10, wherein the steel sheet is plated with Ni or an Fe—Ni alloy on a surface thereof and formed with a base Ni layer, on which base Ni layer an Sn plating is provided, so that part of the Sn plating and part or a whole of the base Ni layer are alloyed by tin melting treatment to form a Sn plating layer containing Sn islands, wherein the base Ni layer contains 5 mg/m² to 150 mg/m² of Ni in terms of Ni metal, and wherein the Sn plating layer contains 300 mg/m² to 3000 mg/m² of Sn in terms of Sn metal.

18. The method of producing a steel sheet for containers according to claim 10, further comprising, after forming the Zr-containing coating on the surface of the steel sheet, performing cleaning treatment by immersion in or by spraying with hot water at 40° C. or more for 0.5 seconds or more.

19. The method of producing a steel sheet for containers according to claim 11, wherein an amount of the attached Zr-containing coating is 1 mg/m² to 100 mg/m² in terms of Zr metal and 0.1 mg/m² or less in terms of F.

20. The method of producing a steel sheet for containers according to claim 11, wherein the solution further contains phosphate ions, and wherein an amount of P in the Zr-containing coating is 0.1 mg/m² to 50 mg/m².

21. The method of producing a steel sheet for containers according to claim 13, wherein the solution further contains phosphate ions, and wherein an amount of P in the Zr-containing coating is 0.1 mg/m² to 50 mg/m².

22. The method of producing a steel sheet for containers according to claim 11, wherein the solution further contains phenolic resin, and wherein an amount of C in the Zr-containing coating is 0.1 mg/m² to 50 mg/m².

23. The method of producing a steel sheet for containers according to claim 12, wherein the solution further contains phenolic resin, and wherein an amount of C in the Zr-containing coating is 0.1 mg/m² to 50 mg/m².

24. The method of producing a steel sheet for containers according to claim 13, wherein the solution further contains phenolic resin, and wherein an amount of C in the Zr-containing coating is 0.1 mg/m² to 50 mg/m².

25. The method of producing a steel sheet for containers according to claim 11, wherein the solution further contains ammonium ions and/or nitrate ions.

26. The method of producing a steel sheet for containers according to claim 12, wherein the solution further contains ammonium ions and/or nitrate ions.

27. The method of producing a steel sheet for containers according to claim 13, wherein the solution further contains ammonium ions and/or nitrate ions.

28. The method of producing a steel sheet for containers according to claim 14, wherein the solution further contains ammonium ions and/or nitrate ions.

29. The method producing a steel sheet for containers according to claim 11, wherein the steel sheet is a surface-treated steel sheet comprising on at least one side thereof a surface treatment layer containing 10 mg/m² to 1000 mg/m² of Ni in terms of Ni metal, or 100 mg/m² to 15000 mg/m² of Sn in terms of Sn metal.
